(19) United States
(12) Patent Application Publication
(10) Pub. No.: US 2011/0236696 A1
(43) Pub. Date: Sep. 29, 2011

(54) HIGH STRENGTH REBAR

(76) Inventors: Winky Lai, Seattle, WA (US); Cameron A. Cossette, Kent, WA (US); James F. Petersen, Sammamish, WA (US)

(21) Appl. No.: 12/732,042

(22) Filed: Mar. 25, 2010

(51) Int. Cl. B32B 15/04; C22C 38/04; C22C 38/12; C22C 38/00; C21C 5/30; C21C 7/00

(52) U.S. Cl. 428/457; 420/120; 420/127; 420/8; 420/123; 420/124; 420/89; 420/93; 420/128; 75/386

(57) ABSTRACT

A high mechanical strength reinforcement steel comprising, in addition to iron, at most about 0.5% by weight carbon, at most about 0.5% by weight vanadium and/or niobium, and the usual residual elements of scrap steel. A method of reinforcing a dwelling from damage resulting from seismic activity, the method comprising providing, as a component of the dwelling, at least one rebar of a composition comprising, in addition to iron, at most about 0.5% by weight carbon, at most about 0.5% by weight vanadium and/or niobium, at most 1.7% by weight of manganese, at most 0.5% by weight of silicon, and the usual residual elements of scrap steel.

### TECHNICAL FIELD

This disclosure relates generally to a high strength, hot rolled steel with high mechanical strength which meets the requirements of construction, in particular, rebar suitable for construction in areas prone to seismic activity, comprising iron, at most about 0.5% by weight carbon, at most about 0.5% by weight vanadium and/or niobium, at most about 1.7% by weight of manganese, at most about 0.5% by weight of silicon, and the usual residual elements of scrap steel.

### BACKGROUND

Concrete is one of the most widely used construction materials, which exhibits a high compressive strength, but a low tensile strength. This drawback of concrete has been solved in construction, at least in part, by introducing in the stress zones of the concrete construction elements, steel rods or other steel reinforcements that absorb and otherwise relieve the tensile stresses from the concrete.

Steel is particularly advantageous in the construction of concrete elements. Such steels must exhibit good carrying capacity and be able to be used in the preparation of constructions, typically by casing with concrete elements. Rebar typically used for concrete reinforcement is generally fabricated in grades of 40, 60, 75, and 80, meaning a minimum absolute strength of 40, 60, 75, and 80 ksi, respectively.

Modern construction regulations and requirements require certain properties and reinforcement densities for such steel elements. Certain steel properties, alone or in combination with concrete elements are not generally obtainable at commercially feasible cost.

### SUMMARY

Disclosed and described herein are steel compositions and fabrication methods for steel rebar having such compositions. Such steel and rebar disclosed herein is generally useful for construction in confinement applications, for example in combination with concrete elements, especially for construction in areas prone to seismic activity. The disclosed and described steel rebar optimizes mechanical strength, thus, enabling reduced amount of steel used while providing the strength required and improves the constructability by reducing congestion in the structure. Methods of improving the resistance of building elements to seismic activity using the steel rebar disclosed herein are also provided.

Thus, in a first embodiment, a high mechanical strength reinforcement steel is provided. The steel consists essentially of, in addition to iron, at most about 0.5% by weight carbon, at most about 0.5% by weight vanadium and/or niobium, at most about 1.7% by weight of manganese, at most about 0.5% by weight of silicon, and the usual residual elements of scrap steel.

In a second embodiment, a high mechanical strength reinforcement steel consisting essentially of, in addition to iron, at least about 0.1% and at most about 0.5% by weight carbon, at least about 0.1% and at most about 0.5% by weight vanadium and/or niobium, at most about 1.7% by weight of manganese, at most about 0.5% by weight of silicon, and the usual residual elements of scrap steel, is provided.

In a third embodiment, a high mechanical strength reinforcement steel is provided. The steel consists essentially of, in addition to iron, at most about 0.5% by weight carbon, at most about 0.5% by weight vanadium and/or niobium, at most about 1.7% by weight of manganese, at most about 0.5% by weight of silicon, at most about 0.05% by weight of molybdenum, at most about 0.7% by weight of copper and/or nickel, at most about 0.1% by weight of phosphorous and/or sulfur, at most 500 ppm of nitrogen, and the usual residual elements of scrap steel.

In a fourth embodiment, a reinforcing bar having the composition of any of the first, second or third embodiments is provided. In one aspect of the fourth embodiment, the reinforcing bar of size #3 rebar to size #18 rebar, has a yield strength of at least 90 ksi. In particular, rebar of size #5 and size #6 having a yield strength of at least 90 ksi is provided.

In a fifth embodiment, a concrete form comprising at least one rebar having a composition of any of the first, second or third embodiments is provided.

In a sixth embodiment, a method of fabricating a high strength rebar is provided. The method comprises providing a scrap metal melt comprising substantially iron and residual elements, analyzing a sample of the scrap metal melt, and adjusting the elemental composition of the scrap metal melt based on the analysis. The adjusted composition provides a size #3 rebar to size #18 rebar sized rebar with a yield strength of at least 90 ksi.

In a first aspect of the sixth embodiment, the melt is adjusted to a composition consisting essentially of, in addition to iron, at most about 0.5% by weight carbon, at most about 0.5% by weight vanadium and/or niobium, at most about 1.7% by weight of manganese, at most about 0.5% by weight of silicon, and the usual residual elements of scrap steel.

In a second aspect of the sixth embodiment, the melt is adjusted to a composition consisting essentially of, in addition to iron, at least about 0.3% and at most about 0.4% by weight carbon, at least about 0.1% and at most about 0.5% by weight vanadium and/or niobium, at most about 1.7% by weight of manganese, at most about 0.5% by weight of silicon, and the usual residual elements of scrap steel.

In a third aspect of the sixth embodiment, the melt is adjusted to a composition consisting essentially of, in addition to iron, at most 0.5% by weight carbon, at most 0.5% by weight vanadium and/or niobium, at most 1.7% by weight of manganese, at most 0.5% by weight of silicon, at most 0.05% by weight of molybdenum, at most 0.7% by weight of copper and/or nickel, at most 0.1% by weight of phosphorous and/or sulfur, at most 500 ppm of nitrogen, and the usual residual elements of scrap steel.

Alone or in combination with any of the previous aspects of the sixth embodiment, the method further comprises hot rolling the melt.

In a seventh embodiment a method of reinforcing a dwelling from damage resulting from seismic activity is provided. The method comprises providing, as a component of the dwelling, at least one rebar of a composition consisting essentially of, in addition to iron, at most about 0.5% by weight carbon, at most about 0.5% by weight vanadium and/or niobium, at most about 1.7% by weight of manganese, at most about 0.5% by weight of silicon, and the usual residual elements of scrap steel.

In a first aspect of the seventh embodiment, the rebar composition is at least about 0.3% and at most about 0.4% by weight carbon, at least about 0.1% and at most about 0.5% by weight vanadium and/or niobium, at most about 1.7% by weight of manganese, at most about 0.5% by weight of silicon, and the usual residual elements of scrap steel.

In a second aspect of the seventh embodiment, the rebar composition consists essentially of, in addition to iron, at most 0.5% by weight carbon, at most 0.5% by weight vanadium and/or niobium, at most 1.7% by weight of manganese, at most 0.5% by weight of silicon, at most 0.05% by weight of molybdenum, at most 0.7% by weight of copper and/or nickel, at most 0.1% by weight of phosphorous and/or sulfur, at most 500 ppm of nitrogen, and the usual residual elements of scrap steel.

In a third aspect of the seventh embodiment, the component of the dwelling comprises a concrete construction element comprising the at least one rebar. Alone or in combination with any of the previous aspects of the seventh embodiment, the rebar is of size #3 rebar to size #18 rebar with a yield strength of at least 90 ksi.

### BRIEF DESCRIPTION OF THE DRAWINGS

FIG. 1 depicts a flow diagram of the process disclosed and described herein.

FIG. 2. is a summary TABLE 1 of iron compositions disclosed and described herein.

FIG. 3. is a summary TABLE 2 of mechanical properties of rebar disclosed and described herein.

### DETAILED DESCRIPTION

Improvements in steel rebar and concrete elements is desirable for construction to reduce weight, cost, constructability, and to provide resistance to damage during seismic activity. Disclosed and described herein are steel compositions and methods of fabricating steel rebar that is particularly advantageous, for example, in the construction of concrete elements with complex properties. Such steel and steel containing concrete elements exhibit good characteristics of carrying capacity and are suitable in the preparation of constructions, for example, by casing the instant rebar with concrete elements, in areas prone to seismic activity.

In one aspect, high strength rebar disclosed and described herein is intended to absorb or eliminate, after their introduction, the tensile and shearing stresses to which the reinforced construction elements are subjected. In one aspect, the rebar disclosed and described herein is provided as reinforcement steel for concrete construction elements. In one aspect, such reinforcement steels can be hot-rolled. In preferred aspects, the high strength steels and rebar formed therefrom are alloyed with vanadium and/or niobium.

In various aspects, the instant high strength rebar is hot-rolled to a predetermined apparent elastic limit, a suitable ductility.

In preferred aspects, the instant high strength rebar provides for increased tensile and yield strength at reduced diameter, for example rebar of grade 90 ksi or higher. Thus, the instant rebar provides for improved reinforcement of concrete, capable of reducing the total weight steel/weight concrete of the construction element and providing excellent stress absorbing properties for building, especially buildings in regions prone to seismic stresses.

In other aspects, the instant high strength rebar, when used as an non pre-stressed reinforcement steel in concrete, exhibits plasticity resistant to cracking of the concrete prior to breaking failure of the steel, such stresses typically resulting from bending stresses during construction and seismic activity after construction.

The steel compositions and rebar disclosed and described herein provide a reinforcement steel that has a high mechanical strength, fabricated in the hot-rolled state, the instant reinforcement steel consists essentially of, in addition to iron, at most 0.5% by weight carbon, at most about 0.5% by weight vanadium and/or niobium, at most about 1.7% by weight of manganese, at most about 0.5% by weight of silicon, at most about 0.05% by weight of molybdenum, at most about 0.7% by weight of copper and/or nickel, at most about 0.1% by weight of phosphorous and/or sulfur, at most about 500 ppm of nitrogen, and the usual residual elements of scrap steel. In certain aspects, the above composition is greater than about 0.1% but less than about 0.5% by weight carbon, and not more than about 0.2% by weight vanadium and/or niobium. In other aspects, the above composition is greater than about 0.30% but less than about 0.4% by weight carbon, not more than 0.2% by weight vanadium and/or niobium, and not less than about 0.05% by weight molybdenum.

In a particularly preferred aspect, a reinforcement steel having a high mechanical strength, fabricated in the hot-rolled state consists essentially of, in addition to iron, of at most about 0.5% by weight carbon, preferably less that about 0.4 wt % carbon, and most preferably between 0.3-0.4 wt % carbon, at most about 0.5% by weight vanadium and/or niobium, preferably at most about 0.3% by weight vanadium and/or niobium, most preferably at most about 0.2% by weight vanadium and/or niobium, at most about 1.7% by weight of manganese, at most about 0.5% by weight of silicon, and the usual residual elements of scrap steel.

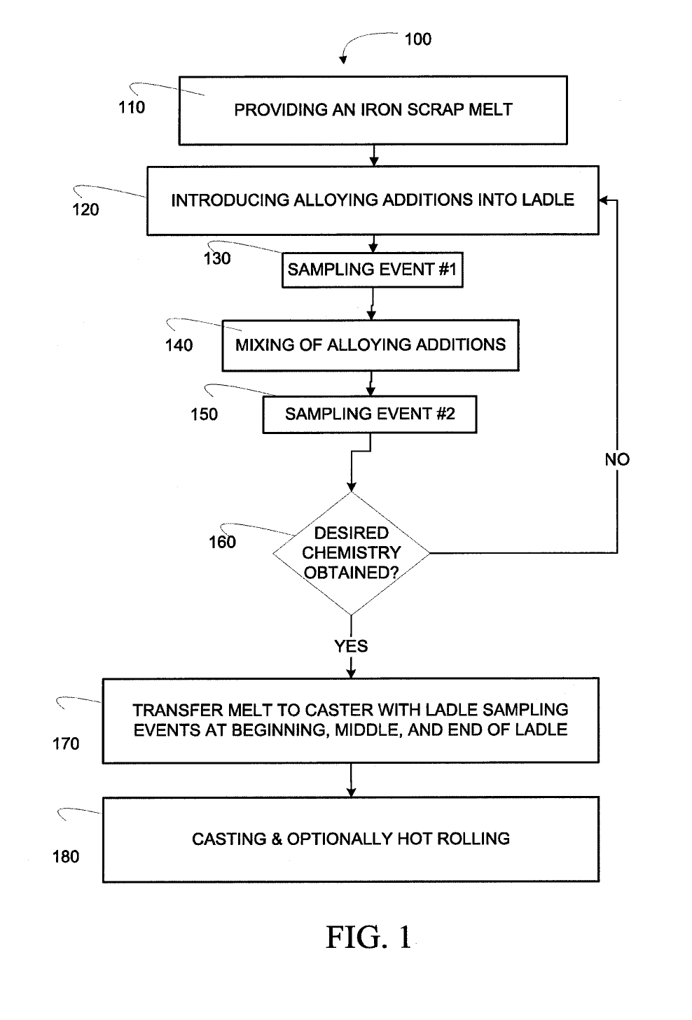

Thus, referring to FIG. 1, process 100 for providing the high strength steel composition is presented. Iron scrap is heated in a furnace to provide scrap melt (block 110). Introduction of alloying additions, e.g., vanadium and/or manganese is performed while the molten steel is tapped into a ladle and positioned at stir station (block 120). Sampling event of the melt for chemical composition is performed (block 130). Stirring and mixing is commenced at stir station to ensure alloy additions added during tap are evenly distributed in melt (block 140). Second sampling event is performed (block 150). Determination of whether the desired chemical composition is obtained by analysis of the melt is performed (block 160). If the desired chemical composition is not obtained, addition of further alloying elements is performed as in block 120 and blocks 130, 140, 150 and 160 are repeated, as necessary. When the desired chemical composition is obtained, the melt is transferred to caster with ladle contents being sampled at beginning of ladle, at about half way thru the ladle, and near the end of ladle (block 170) to ensure homogeneity of the molten steel throughout the cast. Casting of steel is performed (block 180) with optional hot rolling, e.g., to form rebar.

While not being held to any particular theory, it is generally believed that the inclusion formed by combining vanadium and/or niobium with nitrogen and/or carbon in steel is found to promote grain size refinement, increases the strength of the material through the precipitation of the carbides and nitrides of vanadium. While vanadium is a relatively expensive additive for alloy steels, especially considering the relatively low cost scrap steels usually used as to form rebar, it is nonetheless desirable to minimize the amount of vanadium. The instant compositions and methods provides for a balance between the costs of adding vanadium to steel for rebar and the benefits obtained by the improved mechanical properties obtained therefrom over conventional rebar formed from medium carbon steel alloy, for example.

The instant steel compositions provide for rebar with plasticity, capability for hot and cold deformation and useful strength of the reinforcing steel compared to the comparative example of similar, but distinct, composition.

The specific ranges of elements and their proportion disclosed and described herein, provide a reinforcement steel of excellent mechanical strength without cold treatment, post-heat treatments, or deformation treatments, making possible very simply and economically a considerably higher mechanical strength rebar from a heat with favorable rheological properties than that otherwise known for a reinforcement steel derived from scrap.

The instant reinforcement steel disclosed and described herein also contains in its chemical composition certain micro-alloying compounds held within a certain predetermined range that, without being held to any particular theory, provide at least in part, some of the improved tensile and yield properties observed at an otherwise lower carbon content. Thus, the strength of the instant steel is obtained without much of a cost in ductility. Moreover, a reduced diameter of the instant rebar as a reinforced steel significantly reduces the weight of the concrete construction element while the prescribed concrete layer can be maintained.

The reinforcement steel disclosed and described herein can be prepared and worked in installations commonly used for reinforcement steels, eliminating new installations and investments.

The reinforcement steel disclosed and described herein and its mechanical properties are further illustrated by the following examples. The following examples are illustrative of the embodiments presently disclosed, and are not to be interpreted as limiting or restrictive. All numbers expressing quantities of ingredients, reaction conditions, and so forth used herein may be understood as being modified in all instances by the term “about.” Accordingly, unless indicated to the contrary, the numerical parameters set forth herein may be approximations that may vary depending upon the desired properties sought to be obtained. At the very least, each numerical parameter should be construed in light of the number of significant digits and ordinary rounding approaches. Several experimental examples, listed below, were conducted in order to formulate, fabricate, and test the attributes of the instant compositions disclosed herein.

### EXAMPLES

A steel alloy suitable for use in rebar was produced by melting scrap steel in an electric arc furnace. After the melt was formed, samples were taken for analysis. Based on the analysis, appropriate alloying additions were made to the melt. The steps of analysis-alloying additions were repeated as needed to arrive at a heat of predetermined composition. Vanadium and/or niobium were added to the molten steel as one of the alloying additions.

The molten charge can be overheated at a temperature superior to the temperature of the casting and then poured into refining ladles. Analysis of the melt in the ladles can be performed to ensure complete mixing of the alloying additions. Analysis of the melt and alloying additions can be performed with the aid of algorithms, which can further be coupled to and controlled by automated dispensers and the like. For example, algorithmic equations based on prior histories, historical data, previous properties observed, etc., suitable for adjusting the wt % carbon levels with micro-alloying elements such as vanadium and/or niobium and/or manganese etc., to target specific tensile, yield, and elongation properties, can be used. The content of the ladles can then be poured in a continuous casting installation, for example, a predetermined cross sectional billet at about 1850° F. Billets are then reheated to temperature at about 1900° F. and rolled into the desired diameter. The rolled bars are exited from the mill at about 1700° F. into a cooling bed at about 1500° F., and then air cooled. Bars of predetermined diameter were then cut into appropriate lengths. Samples were tested and provided the following mechanical results.

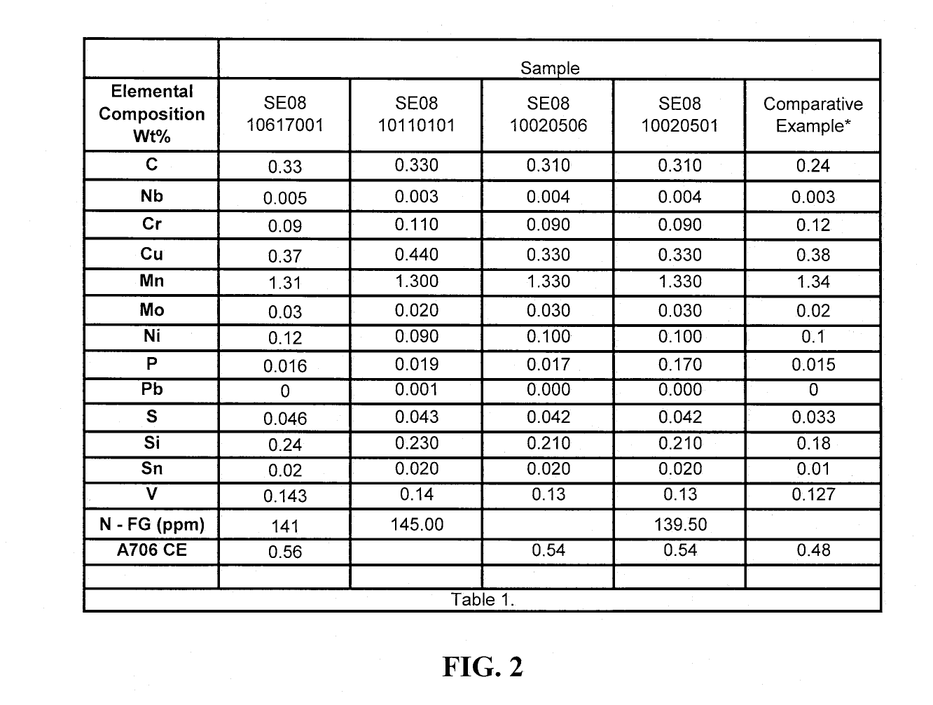

Chemical analysis of the final melts revealed the following composition, in the indicated weight percent ranges unless otherwise indicated, in the proportions indicated in TABLE 1 presented in FIG. 2. It is observed that certain compositions of less than 0.3% carbon by weight and otherwise at most about 0.5% by weight vanadium and/or niobium had yield strengths of less than 90 ksi and would therefore not be suitable for GR90 rebar. In contrast, rebar of a composition of at most about 0.5% by weight carbon, preferably less that about 0.4 wt % carbon, and most preferably between 0.3-0.4 wt % carbon, at most about 0.5% by weight vanadium and/or niobium, preferably at most about 0.3% by weight vanadium and/or niobium, most preferably at most about 0.2% by weight vanadium and/or niobium, at most about 1.7% by weight of manganese, at most about 0.5% by weight of silicon, plus usual residuals, provided GR90 rebar suitable for dwelling construction, for example, in areas prone to seismic activity.

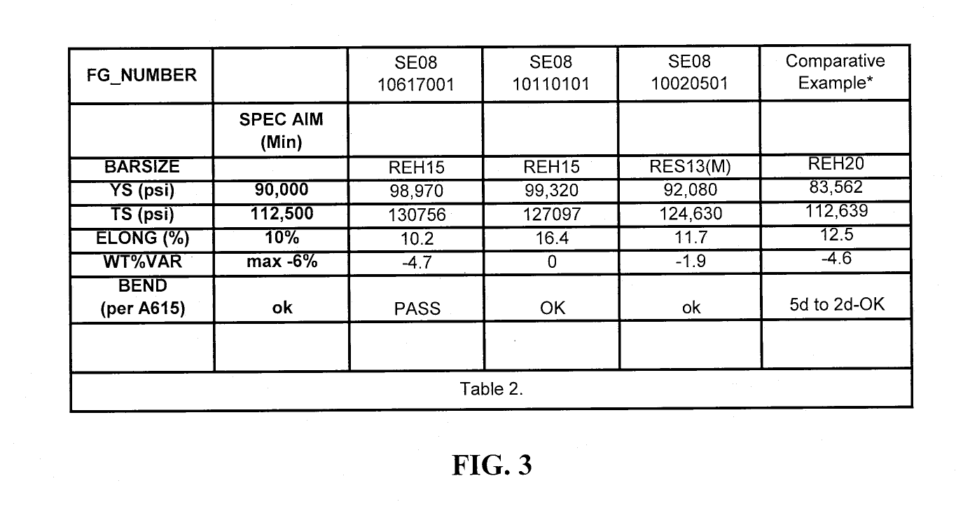

The tensile and yield properties of the instant rebar as a function of the rebar size is summarized in TABLE 2, presented in FIG. 3. Yield strengths of greater than 90 ksi were obtained with tensile strengths of greater than 112 ksi and elongation of greater than 10%, compared with less than 90 ksi for comparative example with similar tensile and elongation properties.

We claim:

1. A high mechanical strength reinforcement steel consisting essentially of, in addition to iron: at most about 0.5% by weight carbon; at most about 0.5% by weight vanadium and/or niobium; at most about 1.7% by weight of manganese; at most about 0.5% by weight of silicon; and the usual residual elements of scrap steel.

2. A high mechanical strength reinforcement steel of claim 1, consisting essentially of, in addition to iron: at least about 0.1% and at most about 0.5% by weight carbon; at least about 0.1% and at most about 0.5% by weight vanadium and/or niobium; at most about 1.7% by weight of manganese; at most about 0.5% by weight of silicon; and the usual residual elements of scrap steel.

3. A high mechanical strength reinforcement steel of claim 1, consisting essentially of, in addition to iron: at most about 0.4 wt % carbon; at most about 0.3% by weight vanadium and/or niobium; at most about 1.7% by weight of manganese; at most about 0.5% by weight of silicon; and the usual residual elements of scrap steel.

4. A high mechanical strength reinforcement steel of claim 1, consisting essentially of, in addition to iron: between 0.3-0.4 wt % carbon; at most about 0.2% by weight vanadium and/or niobium; at most about 1.7% by weight of manganese; at most about 0.5% by weight of silicon; and the usual residual elements of scrap steel.

5. A high mechanical strength reinforcement steel of claim 1, consisting essentially of, in addition to iron: at most about 0.5% by weight carbon; at most about 0.5% by weight vanadium and/or niobium; at most about 1.7% by weight of manganese; at most about 0.5% by weight of silicon; and usual residual elements of scrap steel of at most about 0.05% by weight of molybdenum; at most about 0.7% by weight of copper and/or nickel; at most about 0.1% by weight of phosphorous and/or sulfur; at most 500 ppm of nitrogen.

6. A reinforcing bar having the composition of claim 1.

7. The reinforcing bar of claim 6, wherein the rod is of a size between size #3 rebar to size #18 rebar with a yield strength of at least 90 ksi, preferably a rebar of size #5 or size #6 with a yield strength of at least 90 ksi.

8. A concrete form comprising at least one rebar having a composition defined by claim 1.

9. A method of fabricating a high strength rebar, the method comprising
providing a scrap metal melt comprising substantially iron and residual elements;
analyzing a sample of the scrap metal melt;
adjusting the elemental composition of the scrap metal melt based on the analysis wherein the adjusted composition provides a size #3 rebar to size #18 rebar, with a yield strength of at least 90 ksi.

10. The method of claim 9, wherein the melt is adjusted to a composition consisting essentially of, in addition to iron: at most about 0.5% by weight carbon; at most about 0.5% by weight vanadium and/or niobium; at most about 1.7% by weight of manganese; at most about 0.5% by weight of silicon; and the usual residual elements of scrap steel.

11. The method of claim 9, wherein the melt is adjusted to a composition consisting essentially of, in addition to iron: at least about 0.1% and at most about 0.4% by weight carbon; at least about 0.1% and at most about 0.5% by weight vanadium and/or niobium; at most about 1.7% by weight of manganese; at most about 0.5% by weight of silicon; and the usual residual elements of scrap steel.

12. The method of claim 9, wherein the melt is adjusted to a composition consisting essentially of, in addition to iron: at most about 0.4 wt % carbon; at most about 0.3% by weight vanadium and/or niobium; at most about 1.7% by weight of manganese; at most about 0.5% by weight of silicon; and the usual residual elements of scrap steel.

13. The method of claim 9, wherein the melt is adjusted to a composition consisting essentially of, in addition to iron: between 0.3-0.4 wt % carbon; at most about 0.2% by weight vanadium and/or niobium; at most about 1.7% by weight of manganese; at most about 0.5% by weight of silicon; and the usual residual elements of scrap steel.

14. The method of claim 9, further comprising hot rolling the melt.

15. A method of reinforcing a dwelling from damage resulting from seismic activity, the method comprising;
providing, as a component of the dwelling, at least one rebar of a composition consisting essentially of, in addition to iron: at most about 0.5% by weight carbon; at most about 0.5% by weight vanadium and/or niobium; at most about 1.7% by weight of manganese; at most about 0.5% by weight of silicon; and the usual residual elements of scrap steel.

16. The method of claim 15, wherein the rebar composition consists essentially of, in addition to iron: at least about 0.1% and at most about 0.5% by weight carbon; at least about 0.1% and at most about 0.5% by weight vanadium and/or niobium; at most about 1.7% by weight of manganese; at most about 0.5% by weight of silicon; and the usual residual elements of scrap steel.

17. The method of claim 15, wherein the rebar composition consisting essentially of, in addition to iron: at most about 0.4 wt % carbon; at most about 0.3% by weight vanadium and/or niobium; and the usual residual elements of scrap steel.

18. The method of claim 15, wherein the rebar composition consisting essentially of, in addition to iron: between 0.3-0.4 wt % carbon; at most about 0.2% by weight vanadium and/or niobium; and the usual residual elements of scrap steel.

19. The method of claim 15, wherein the component of the dwelling comprises a concrete construction element comprising the at least one rebar.

20. The method of claim 15, wherein the rebar is of size of one of size #3 rebar to size #18 rebar, with a yield strength of at least 90 ksi, preferably a rebar of size #5 or size #6 with a yield strength of at least 90 ksi.
